(19) United States
(12) Patent Application Publication
(10) Pub. No.: US 2024/0422675 A1
(43) Pub. Date: Dec. 19, 2024

(54) SYSTEMS AND METHODS FOR POWER SAVING IN A TRANSMIT-AND-RECEIVE POINT (TRP)

(71) Applicant: Huawei Technologies Co., Ltd., Shenzhen (CN)

(72) Inventors: Yongxia Lyu, Kanata (CA); Jianglei Ma, Ottawa (CA); Peiying Zhu, Kanata (CA); Xiaoyan Bi, Ottawa (CA)

(21) Appl. No.: 18/806,232

(22) Filed: Aug. 15, 2024

Related U.S. Application Data
(63) Continuation of application No. PCT/CN2022/076533, filed on Feb. 16, 2022.

(51) Int. Cl. H04W 52/02; H04W 24/10

(52) U.S. Cl. CPC H04W 52/0229; H04W 24/10

(57) ABSTRACT

It is desired to try to reduce power consumption in a transmit-and-receive point (TRP) in a wireless network. In some embodiments, to try to reduce overall power consumption, multiple (e.g. two) sets of radio frequency (RF) components are utilized by a TRP, one set having lower power consumption than the other set(s), and switching between the different sets during operation. For example, a TRP may include a first radio frequency unit (RFU) and a second RFU. The second RFU is designed to have higher power consumption than the first RFU. During operation, the TRP uses the second RFU to perform wireless communication in response to a trigger, and otherwise uses the first RFU to perform wireless communication.

### CROSS-REFERENCE TO RELATED APPLICATION

This application is a continuation of International Patent Application No. PCT/CN2022/076533, filed Feb. 16, 2022.

### TECHNICAL FIELD

The present application relates to operation of a transmit-and-receive point (TRP) in a wireless communication system.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a TRP may wirelessly transmit information to a UE in a downlink communication over a particular frequency (or range of frequencies) for a particular duration of time. The frequency and time duration are examples of resources, typically referred to as time-frequency resources. In some cases, the time-frequency resources may be partitioned into blocks of time-frequency resources, referred to as physical resource blocks (PRBs).

Wireless communications between TRPs and UEs may be referred to as wireless traffic. The amount of wireless traffic is expected to grow over the coming decades, e.g. due to the rise in the quantity and types of devices communicating over the Internet. At the same time, operators of wireless networks desire or require to reduce power consumption in their wireless networks, e.g. to help with meeting climate change targets and/or to meet mandatory requirements related to greenhouse gas emissions imposed by countries, agreements or governing bodies. The TRPs often account for a relatively large portion of the power consumed by a wireless network. Therefore, it is desired to try to reduce the amount of power consumed by a TRP.

### SUMMARY

A TRP typically includes a radio frequency unit (RFU). One example of an RFU is a remote radio unit (RRU). Another example of an RFU is an active antenna unit (AAU). The RFU includes RF components for transmitting and receiving the wireless signals. An RF component may alternatively be called an analog component. A non-exhaustive list of examples of RF components includes: crystal oscillators, power amplifiers, analog filters, intermediate frequency (IF) convertors, radio frequency (RF) convertors, phase shifters, etc.

The RFU typically consumes the majority of the power consumed by a TRP. Even if the TRP includes other components separate from the TRP, e.g. a baseband unit (BBU), the RFU still typically consumes the majority of the power. For example, if the RFU is implemented as an AAU, the RFU may consume 90% of all the power consumed by the TRP, even if the TRP also includes a BBU. Therefore, reducing the power consumed by the RFU may notably reduce the power consumed by the TRP as a whole.

One way to try to reduce the power consumed by the RFU is to reduce the performance of the RFU, e.g. reduce the number of power amplifiers and/or reduce the maximum transmit power and/or remove certain IF components and/or use lower performance RF components, etc. However, the RFU is designed to meet the high-performance requirements of the TRP, e.g. to accommodate large traffic loads and/or poor channel conditions. Therefore, reducing the performance of the RFU impacts the TRPs ability to service a large traffic load and/or causes the TRP to not meet certain key performance indicator (KPI) requirements, such as user perceived throughput (UPT).

When the RFU is not being used (e.g. there is no wireless communication with any UEs), the RFU still remains in a “waiting” state ready to wirelessly communicate with a UE. The power consumed by the RFU during the waiting state is referred to as the static power consumption. The static power consumption may be 30% of the typical power consumed by the RFU when the RFU is performing wireless communication. Another way to try to reduce the power consumption of the RFU is to keep the RFU powered off or in a lower power sleep state during periods when the RFU is not being used. However, it is often not possible to know when the RFU will need to perform wireless communication, and the time to transition back to a state in which the RFU is ready to wirelessly communicate may be too long (e.g. several minutes), which may not be practical or meet certain KPIs.

Therefore, it is not clear how to reduce the power consumption in an RFU, and it poses a technical challenge.

In some embodiments herein, to try to reduce overall power consumption, multiple (e.g. two) sets of RF components are utilized by a TRP, one set having lower power consumption than the other set(s), and switching between the different sets during operation.

One example is as follows. A TRP includes a first RFU and a second RFU. The second RFU is designed to have higher power consumption than the first RFU. For example, the second RFU may be the same as or similar to an RFU that is currently deployed in TRPs and is designed to accommodate the high-performance requirements of the TRP, such as the situation of high traffic load (e.g. communicating with many UEs at the same time), and/or poor wireless channel conditions, and/or interference due to the presence of many UEs, etc. The first RFU is designed to consume less power than the second RFU. The first RFU may achieve the lower power consumption by having fewer RF chains (e.g. fewer power amplifiers) and/or fewer RF components and/or lower performance RF components (e.g. lower power and/or lower quality RF components), etc., compared to the second RFU. During operation, the TRP uses the second RFU to perform wireless communication in response to a trigger, and otherwise uses the first RFU to perform wireless communication. An example of a trigger may be time of day and/or high traffic load and/or poor wireless channel condition, etc. For example, the first RFU may be used during off-peak times (e.g. middle of the night) if there is a low traffic load, and meets the required performance targets even with a lower power consumption because of the lower traffic load and less interference. The second RFU is used during on-peak times (e.g. late afternoon) and/or when there is a high traffic load, and the higher performance/higher power second RFU meets the required performance targets because it can accommodate the traffic load demands. Although there is an increase in total number of RF components in the TRP, e.g. two RFUs instead of one RFU, there may be overall power savings because the TRP may be able to wirelessly communicate using the first RFU during much of the time and only temporarily switch to the higher-power second RFU for wireless communication.

In one embodiment, there is provided a method performed by a device, e.g. a network device such as a TRP, in a wireless network. The device includes a first set of RF components and a different second set of RF components. The method may include performing wireless communication using the first set of RF components and not the second set of RF components. The method may further include, in response to a trigger: instead performing wireless communication using the second set of RF components and not the first set of RF components. The first set of RF components may consume less power than the second set of RF components. For example, the first set of RF components may comprise a first RFU and the second set of RF components comprises a different second RFU. The first RFU may have fewer power amplifiers than the second RFU.

A technical benefit of some embodiments includes possible power savings compared to previous TRPs, because of the provision of a set of RF components having lower power consumption and the use of those RF components for wireless communication during operation.

In some embodiments, a UE may receive from the network (e.g. from the TRP), an indication of the set of RF components being used by the TRP to wirelessly communicate with the UE. If the TRP is using the lower power RF components, the UE may operate in a different mode of operation with the TRP compared to when the TRP is using the higher power RF components. The different modes of operations may be such that fewer bits are wirelessly communicated in order to indicate a particular value (e.g. channel quality indicator (CQI) or modulation-and-coding (MCS) scheme) when the TRP is wirelessly communicating using the lower power RF components compared to when the TRP is wirelessly communicating using the higher power RF components.

In one embodiment, there is provided a method performed by an apparatus, such as a UE. The method may include receiving, from a TRP, a first indication that the TRP is performing wireless communication using a first set of RF components different from a second set of RF components. In response to receiving the first indication, the method may further include: wirelessly communicating with the TRP in a first mode of operation different from a second mode of operation. In some embodiments, fewer bits are wirelessly communicated in order to indicate a particular value when operating in the first mode of operation compared to when operating in the second mode of operation. In some embodiments, the method may further include subsequently receiving, from the TRP, a second indication that the TRP is performing wireless communication using the second set of RF components. In response to receiving the second indication, the method may further include: wirelessly communicating with the TRP in the second mode operation.

The first set of RF components may consume less power than the second set of RF components. An example technical benefit of some embodiments may be reduced transmission overhead during the mode of operation in which the lower power RF components are being used.

Corresponding devices and apparatuses for performing the methods herein are also disclosed.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates a user equipment (UE) communicating with a TRP, according to one embodiment;

FIGS. 6 to 8 illustrate example TRPs;

FIG. 9 illustrates an example TRP in which RFU 1 has two RF chains and RFU 2 has 32 RF chains;

FIGS. 10 to 12 illustrate example RFUs;

FIGS. 13 to 15 illustrate examples of an apparatus communicating with a TRP;

FIG. 16 illustrates a method performed by TRP, according to one embodiment;

FIG. 17 illustrates a TRP communicating with a UE, according to one embodiment;

FIG. 18 illustrates a method performed by TRP and UE, according to one embodiment; and

FIGS. 19 and 20 each illustrate a method performed by a UE, according to various embodiments.

### DETAILED DESCRIPTION OF THE EMBODIMENTS

For illustrative purposes, specific example embodiments will now be explained in greater detail below in conjunction with the figures.

### Example Communication Systems and Devices

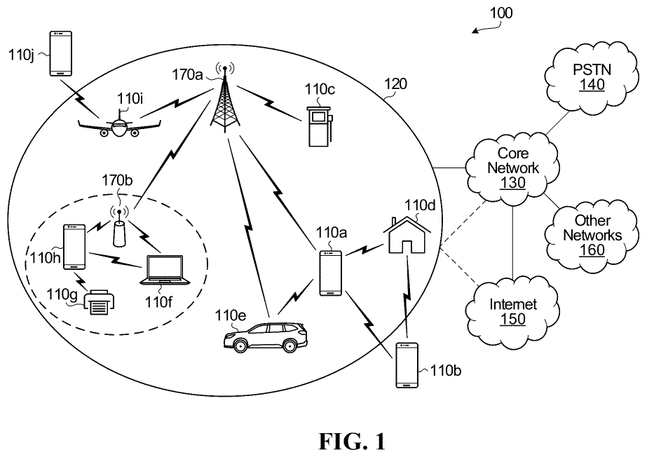

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

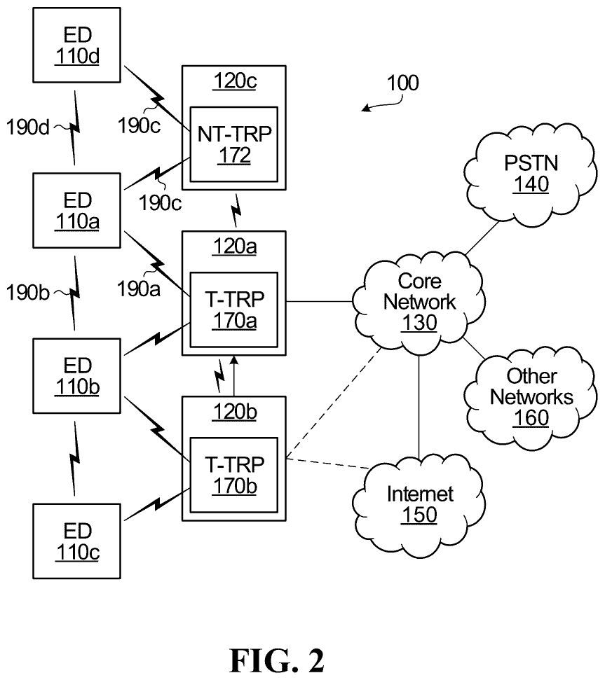

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

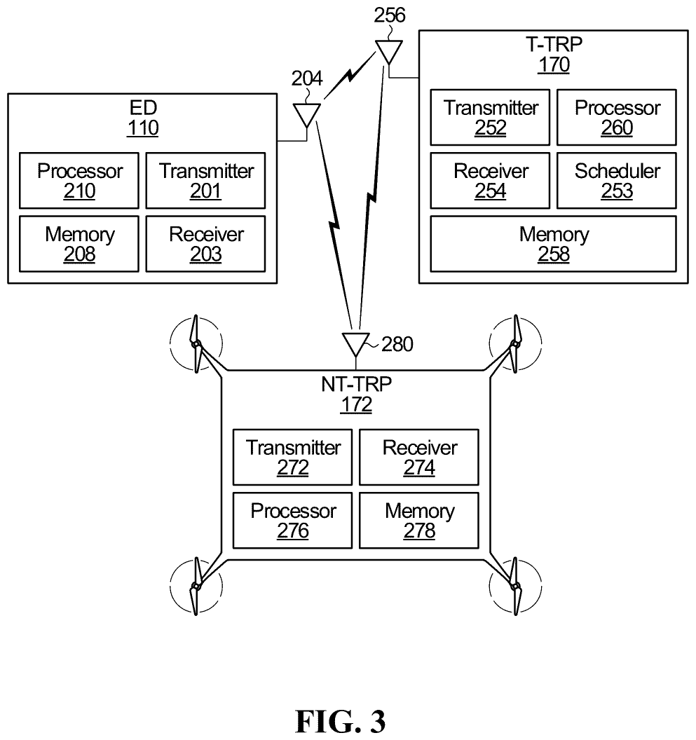

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, baseband unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

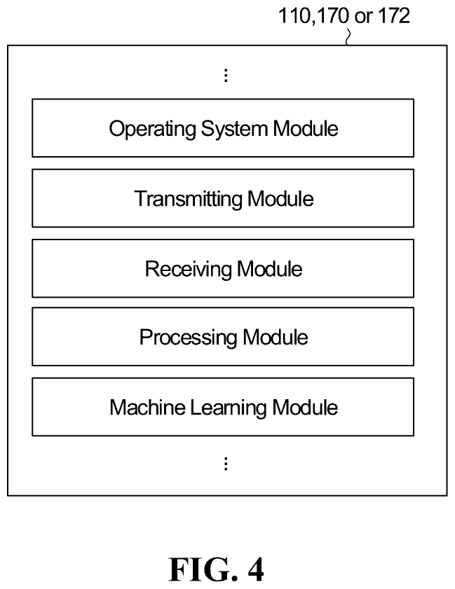

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

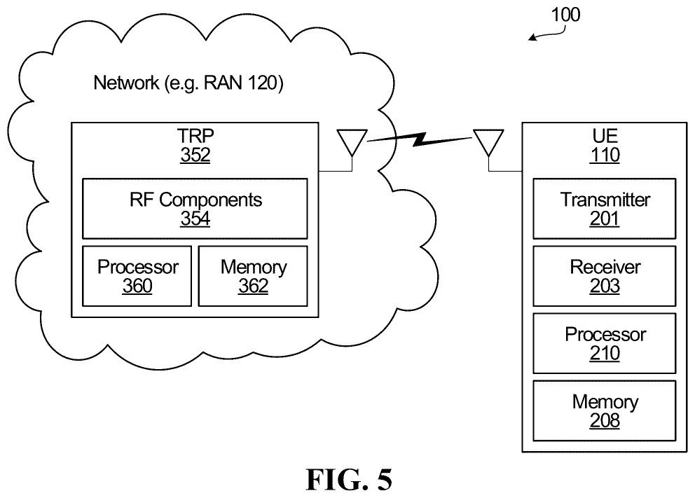

FIG. 5 illustrates an ED communicating with a TRP 352 in the communication system 100, according to one embodiment. The ED will be referred to as a user equipment (UE) 110 herein. The UE 110 represents any suitable end user device for wireless operation and may include devices such as (but not limited to) a smartphone, a laptop, a computer, a tablet, a wireless sensor, a consumer electronics device, a smart book, a vehicle, a car, a truck, a bus, a train, an IoT device, an industrial device, a cellular telephone, a station (STA), a machine type communication (MTC) device, a personal digital assistant (PDA), a wireless transmit/receive unit (WTRU), a mobile station, a fixed or mobile subscriber unit, or an apparatus (e.g. communication module, modem, or chip) in any of the forgoing devices.

The TRP 352 may be T-TRP 170 or NT-TRP 172. In some embodiments, the parts of the TRP 352 may be distributed. For example, some of the modules of the TRP 352 may be located remote from the equipment housing the antennas of the TRP 352, and may be coupled to the equipment housing the antennas over a communication link (not shown). For example, a baseband unit (BBU) of the TRP 252 may be remote from the RF unit (RFU) of the TRP 352. As another example, the antenna(s) of the TRP 352 may be remote from the RFU of the TRP 352, or alternatively the antenna(s) may be integrated into the RFU. Because the TRP 352 may be distributed, in some embodiments the term TRP 352 may also or instead refer to modules on the network side that perform processing operations, such as resource allocation (scheduling), message generation, encoding/decoding, etc., and that are not necessarily part of the equipment housing the antennas of the TRP 352. The modules may also be coupled to other TRPs. The term antenna, as used herein, also encompasses a panel, e.g. a panel antenna.

The TRP 352 includes RF components 354 for performing wireless communication by transmitting and/or receiving wireless signals. Examples of RF components 354 are discussed and illustrated later and may include one or more RFUs, or one or more components of the one or more RFUs. The TRP 352 further includes a processor 360 for performing digital operations and computations. In some embodiments, the processor 360 may implement a BBU of the TRP 352. In some embodiments, the processor 360 performs switching between different sets of RF components, e.g. by issuing a control signal controlling a switch. The switch may be implemented by one or more electromechanical devices comprising moveable electrical contacts. In some embodiments, the processor 360 performs the switching in response to a trigger. In some embodiments, the trigger may be determined using a message received by the processor 360. The TRP 352 further includes a memory 362 for storing information (e.g. control information and/or data).

The processor 360 may be implemented by the same or different one or more processors that are configured to execute instructions stored in a memory (e.g. in memory 362). Alternatively, some or all of the processor 360 may be implemented using dedicated circuitry, such as a programmed FPGA, a GPU, or an ASIC. The processor 360 may directly perform, or control one or more components of the TRP 352 to perform, the operations of the TRP 352 described herein, e.g. operations such as performing wireless communication using a first or second set of RF components, switching between the RF components, e.g. in response to a trigger, performing a network access procedure with a UE, etc.

If the TRP 352 is T-TRP 170, then the RF components 354, possibly along with the processor 360, may implement transmitter 252 and receiver 254. The processor 360 may be or include processor 260 and may implement scheduler 253, and the memory 362 may be or include memory 258. If the TRP 352 is NT-TRP 172, then the RF components 354, possibly along with the processor 360, may implement transmitter 272 and receiver 274. The processor 360 may be or include processor 276, and the memory 362 may be or include memory 278.

UE 110 includes processor 210, memory 208, transmitter 201, and receiver 203, as described earlier. The processor 210 may directly perform (or control the UE 110 to perform) much of the operations described herein as being performed by the UE 110, e.g. receiving an indication that the TRP is performing wireless communication using a particular set of RF components (e.g. using the first set of RF components or the second set of RF components), decoding the indication, operating in a particular mode of operation (e.g. a first or second mode of operation) based on the indication, including performing wireless communication in that mode of operation, receiving and decoding DCI, performing a channel measurement, encoding and transmitting a measured channel parameter (e.g. CQI), completing a network access procedure with a TRP, etc.

Although not illustrated, the processor 210 may form part of the transmitter 201 and/or receiver 203. Although not illustrated, the memory 208 may form part of the processor 210.

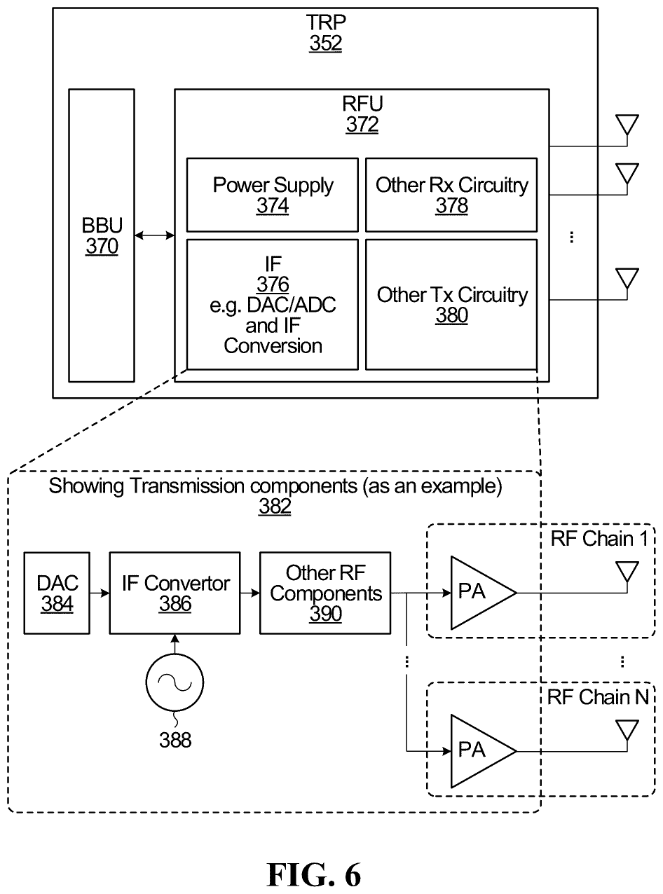

One example of TRP 352 is illustrated in FIG. 6. The TRP 352 includes a baseband unit (BBU) 370, which may be implemented by processor 360. The TRP 352 further includes an RFU 372, which comprise a part of or all of the RF components 354. The RFU 372 includes a power supply 374. The RFU 372 further includes an intermediate frequency (IF) component, referred to as IF 376. The IF 376 performs IF up-conversion and down-conversion and may be implemented by a single chip that also integrates other components, e.g. digital-to-analog conversion (DAC) and/or analog-to-digital conversion (ADC). The RFU 372 further includes other receive circuitry 378 and other transmit circuitry 380, which may include RF components such as (but not limited to): RF convertor(s), power amplifier(s), filter(s), phase shifter(s), crystal oscillator(s), etc.

An example of some of the transmission components of the RFU 372 are illustrated in stippled bubble 382. Transmission components may include DAC 384, IF convertor 386, with associated crystal oscillator 388, and other RF components 390. Examples of other RF components 390 may include RF convertor(s), filter(s), phase shifter(s), and/or crystal oscillator(s). Furthermore, N RF chains are implemented, where N is an integer greater or equal to one. Example values of N include: 4, 8, 16, 32, or 64. Each RF chain includes a respective different power amplifier (PA). Each RF chain includes a physical antenna. In implementation, each physical antenna may actually be a plurality of antennas. Each RF chain may possibly include one or more other RF components, e.g. a component immediately prior to the power amplifier, such as a phase shifter.

The RFU 372 typically consumes the majority of the power consumed by the TRP 352. Therefore, reducing the power consumed by the RFU 372 may notably reduce the power consumed by the TRP 352 as a whole.

The power consumption of the RFU 372 typically varies with traffic load. For example, in general, more power is consumed by the power amplifier(s) if a larger number of UEs are being served by the TRP 352. In the case of poor channel conditions, even if the physical resource block (PRB) usage ratio is low (e.g. only 6-7% of the time-frequency PRBs in the downlink are utilized to carry information/data), many or all of the N RF chains may be utilized for transmit/receive diversity. This may notably increase power consumption, e.g. because of the use of many or all of the power amplifiers, one in each RF chain.

There are also RF components of the RFU 372 that have a power consumption that does not necessarily vary much or at all with traffic load, e.g. the power consumed by crystal oscillator 388.

One way to try to reduce the total power consumed by the RFU 372 is to reduce the performance of the RFU 372, e.g. reduce the number of RF chains and/or reduce the maximum transmit power and/or remove certain RF components, etc. However, the RFU 372 is designed to meet the high-performance requirements of the TRP 352, e.g. to accommodate large traffic loads and/or poor channel conditions. Therefore, reducing the performance of the RFU 372 impacts the TRPs ability to service a large traffic load and/or causes the TRP to not meet certain KPI requirements.

When the RFU 372 is not being used (e.g. there is no wireless communication with any UEs), the RFU 372 still remains in a “waiting” state ready to wirelessly communicate with a UE. The power consumed by the RFU 372 during the waiting state is referred to as the static power consumption. The static power consumption may be 30% of the typical power consumed by the RFU 372 when the RFU 372 is performing wireless communication. The static power consumption may include the power required to keep certain components synchronized and running. Another way to try to reduce the power consumption of the RFU 372 is to keep the RFU 372 powered off or in a lower power sleep state during periods when the RFU 372 is not being used. However, it is often not possible to know when the RFU 372 will need to perform wireless communication, and the time to transition back to a state in which the RFU 372 is ready to wirelessly communicate may be too long (e.g. several minutes), which may not be practical or meet certain KPIs.

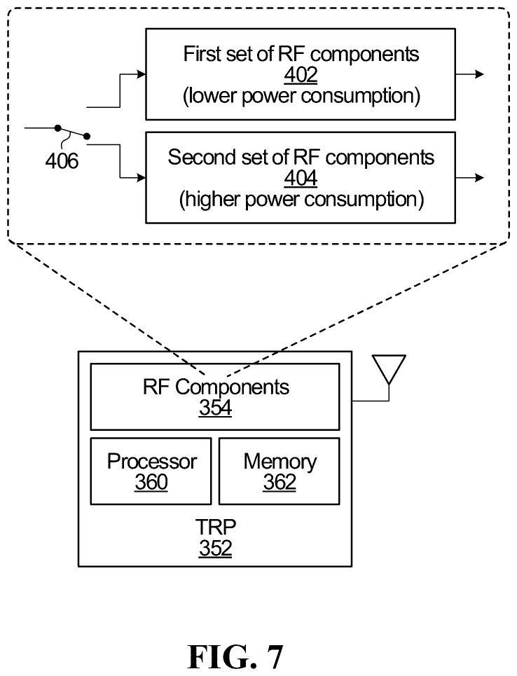

In some embodiments, to try to reduce overall power consumption, multiple (e.g. two) sets of RF components utilized by a TRP, one set having lower power consumption than the other set(s), and switching between the different sets during operation. An example is illustrated in FIG. 7 in which TRP 352 includes a first set of RF components 402 (e.g. a first RFU), a second set of RF components 404 (e.g. a different second RFU), and a switch 406 for switching between the first and second sets of RF components. The switch may be controlled by processor 360, e.g. in response to a trigger. The second set of RF components 404 is designed to have higher power consumption than the first set of RF components 402. For example, the second set of RF components 404 may be or include RFU 372 of FIG. 6 that is designed to accommodate the high-performance requirements of the TRP 352, such as the situation of high traffic load (e.g. communicating with many UEs at the same time), and/or poor wireless channel conditions, and/or interference due to the presence of many UEs, etc. The first set of RF components 402 is designed to consume less power. In some embodiments, during operation the TRP 352 uses the second set of RF components 404 to perform wireless communication in response to a trigger, and otherwise uses the first set of RF components 402 to perform wireless communication. An example of a trigger may be time of day and/or high traffic load and/or poor wireless channel condition, etc. Example triggers are discussed in detail later.

In one example, the first set of RF components 402 may be used during off-peak times (e.g. middle of the night) and/or if there is a low traffic load. The required performance targets may be met even with a lower power consumption because of the lower traffic load and less interference. The second set of RF components 404 is used during on-peak times (e.g. late afternoon) and/or when there is a high traffic load. The higher performance/higher power second set of RF components 404 meets the required performance targets because it can accommodate the traffic load demands.

Although there may be an increase in total number of RF components 354 in the TRP 352 (due to the provision of both first and second separate sets of RF components 402 and 404), there may be overall power savings because the TRP 352 may be able to wirelessly communicate using the first set of RF components 402 during much of the time and only temporarily switch to the higher-power second set of RF components 404 for wireless communication. The power consumption may therefore change with demand associated with the UE(s) serviced by the TRP 352, e.g. in response to increased traffic and/or poor wireless channel condition, by the TRP 352 switching between the first set of RF components 402 and the second set of RF components 404. The first set of RF components 402 may be designed primarily to save power consumption, and the second set of RF components 404 may be designed primarily to meet the target high-performance requirements of the TRP 352, e.g. support high system capacity and/or high user-perceived throughput (UPT).

When the first set of RF components 402 is said to “consumes less power” than the second set of RF components 404, the following is meant. For the same operating conditions, on average the first set of RF components 402 consumes less power than the second set of RF components 404. As one example, the static power consumption of the first set of RF components 402 may be less (on average) than the static power consumption of the second set of RF components 404, where static power consumption refers to an operating state in which the set of RF components are powered and ready for wireless communication but are not performing wireless communication. As another example, when wirelessly communicating with a particular number of UEs for a particular time duration, the power consumption of the first set of RF components 402 may be less (on average) than the power consumption that would be used by the second set of RF components 404 for communicating with those same UEs for the same time duration.

Example ways to implement the lower power consumption of the first set of RF components 402 compared to the second set of RF components 404 include: the first set of RF components 402 having a fewer number of RF chains and/or power amplifiers compared to the number of RF chains and/or power amplifiers in the second set of RF components 404; and/or the first set of RF components 402 having a reduced circuit chip area compared to the circuit chip area of the second set of RF components 404; and/or the first set of RF components 402 having a reduced RF component size compared to the RF component size of the second set of RF components 404; and/or the first set of RF components 402 having a fewer number of RF components compared to the number of RF components in the second set of RF components 404; and/or the first set of RF components 402 having a fewer number of crystal oscillators compared to the number of crystal oscillators in the second set of RF components 404; and/or the first set of RF components 402 having a fewer number of filters compared to the number of filters in the second set of RF components 404; and/or the first set of RF components 402 omitting IF conversion; and/or reducing the maximum transmission power of the first set of RF components 402 compared to the second set of RF components 404.

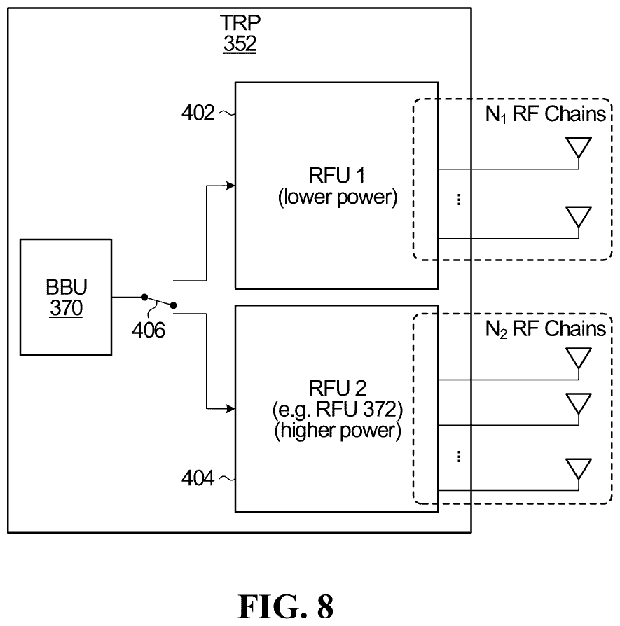

FIG. 8 illustrates TRP 352, according to one embodiment. The first set of RF components 402 comprises a first RFU, referred to as “RFU 1”. The second set of RF components 404 comprises a different second RFU, referred to as “RFU 2”. Both RFU 1 and RFU 2 communicate with the same BBU 370. RFU 1 consumes less power than RFU 2.

RFU 1 includes N₁ RF chains, whereas RFU 2 includes N₂ RF chains. N₁ and N₂ are each an integer greater than zero, and N₂≥N₁. In one implementation, RFU 2 is RFU 372 and is designed primarily to meet the target high-performance requirements of the TRP 352, e.g. support high system capacity and/or high user-perceived throughput, whereas RFU 1 is a lower-power RFU.

In operation, switch 406 is used to switch between RFU 1 and RFU 2. Switch 406 may be controlled by processor 360. Only one RFU is used at a time for wireless communication. In some embodiments, a trigger causes a switch from RFU 1 to RFU 2. For example, RFU 1 may be used by default for wireless communication, but in response to a trigger the TRP 352 switches to use RFU 2 instead, e.g. by switch 406 connecting BBU 370 to RFU 2 instead of RFU 1. Examples of triggers are described in more detail later, e.g. a trigger might be time of day and/or high traffic load and/or poor wireless channel condition, etc.

One way for RFU 1 to consume less power than RFU 2 is for RFU 1 to implement fewer RF chains, i.e. N₁<N₂. In one example, N₁ equals one or two or four, and N₂ equals 16 or 32 or 64 or 128.

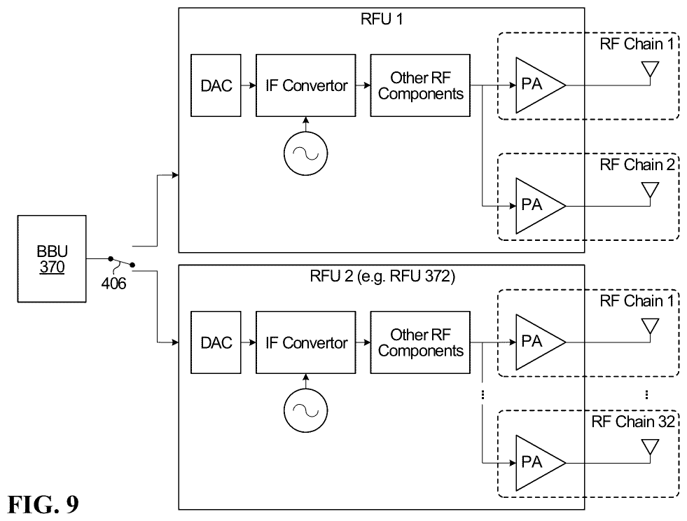

FIG. 9 illustrates an example in which RFU 1 has two RF chains and RFU 2 has 32 RF chains. Each RF chain includes a respective power amplifier. Fewer RF chains means less transmit diversity, but ability for more power savings, e.g. by the provision of fewer power amplifiers. FIG. 9 also illustrates some of the transmission components of each RFU, e.g. a DAC, IF convertor, and other RF components.

Although FIG. 9 illustrates RFU 1 having fewer RF chains than RFU₂, this does not necessarily need to be the case. RFU 1 and RFU 2 may have the same number of RF chains, and RFU 1 may implement power savings in another way instead, e.g. by RFU 1 implementing reduced circuit chip area and/or lower quality components and/or reduced RF component size and/or fewer number of RF components and/or lower maximum transmission power, etc., compared to RFU₂.

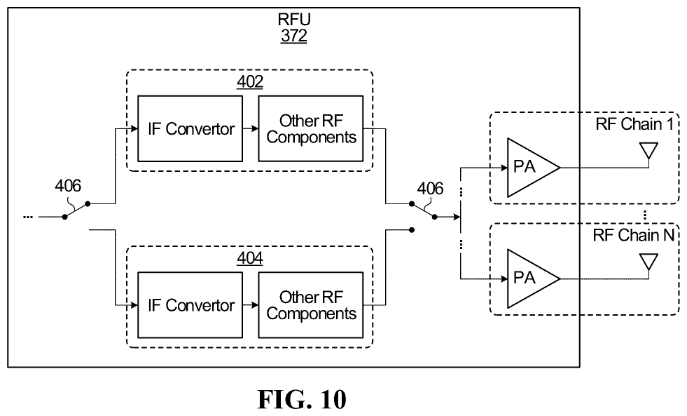

FIG. 10 illustrates a different example in which the first set of RF components 402 and the second set of RF components 404 are each a separate set of RF components implemented in a same RFU, which in the example is RFU 372. The first set of RF components 402 and the second set of RF components 404 implement the same function, but the first set of RF components 402 consumes less power than the second set of RF components 404. The reduced power consumption may be implemented in any of the ways described herein, e.g. implementing reduced circuit chip area and/or lower quality components and/or reduced RF component size and/or fewer number of RF components, etc. The first set of RF components 402 is designed for power savings, and the second set of RF components 404 is designed to meet the high-performance requirements of the TRP 352, e.g. support high system capacity and/or high user-perceived throughput. In operation, switch 406 is used to switch between the first set of RF components 402 and the second set of RF components 404. Only one set of RF components is used at a time for wireless communication. In some embodiments, a trigger causes a switch from one set of RF components to the other set of RF components.

In the example in FIG. 10, only transmission components are illustrated. The first set of RF components 402 includes an IF component (e.g. IF convertor and possibly DAC), and other RF components (e.g. filters, RF convertor, etc.). The second set of RF components 404 also includes an IF component and other RF components.

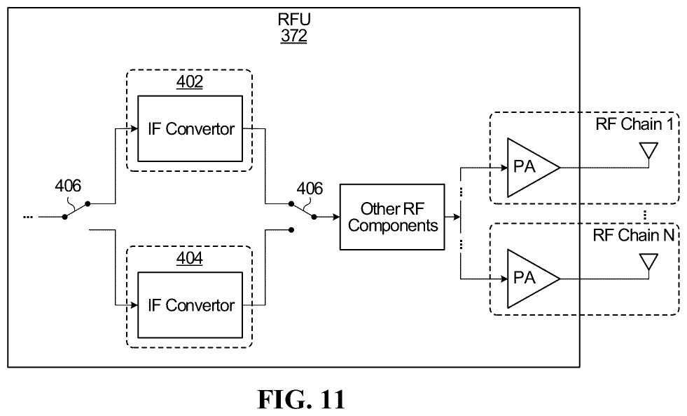

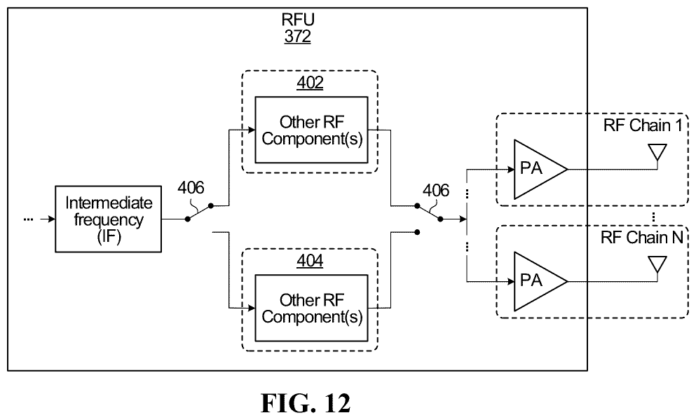

FIG. 11 illustrates a variation of FIG. 10 in which the first set of RF components 402 and the second set of RF components 404 each include only an IF component. FIG. 12 illustrates a variation of FIG. 10 in which the first set of RF components 402 and the second set of RF components 404 each include only other RF components different from the IF components and RF chains.

In each of the embodiments in FIGS. 10 to 12, the number of RF chains remains the same. Therefore, unlike the embodiment in FIG. 9, in the embodiments in FIGS. 10 to 12 there are no power savings possible by way of the implementation of fewer RF chains. The number of RF chains (N) remains the same for each of the embodiments in FIGS. 10 to 12. However, the embodiments in FIGS. 10 to 12 have the benefit of some power savings with possibly less cost, e.g. because there are not two separate RFUs.

In some embodiments, it may be the case that: (1) the embodiment in FIG. 9 has the most power saving potential, but the most cost because of the provision of two separate RFUs; (2) the embodiment in FIG. 10 has less power saving potential (compared to the embodiment in FIG. 9), but less cost (compared to the embodiment in FIG. 9) because rather than two separate RFUs there are some RF components in a single RFU that are not being duplicated, e.g. the RF chains remain the same regardless of whether the first set of RF components 402 or the second set of RF components 404 are being used for wireless communication; (3) the embodiments in FIGS. 11 and 12 have even less power saving potential (compared to the embodiment in FIG. 10) but even less cost (compared to the embodiment in FIG. 10) because fewer RF components are being duplicated.

### Trigger to Switch Between First and Second Sets of RF Components

In the embodiments described above in relation to FIGS. 7 to 12, the TRP 352 performs wireless communication using either the first set of RF components 402 or the second set of RF components 404. A switch 406 is used to switch between the two sets.

In some embodiments, switching between the first set of RF components 402 and the second set of RF components 404 occurs in response to a trigger. Some examples of possible triggers are described below.

In some embodiments, the trigger is a message from an apparatus indicating the switch is to occur. As discussed later, the apparatus may be another device separate from the TRP 352, e.g. it may be a network node such as a server in the network, another TRP, or a “super” TRP. The message from the apparatus may comprise a payload that includes a “switch indicator” bit value. The bit value may be one or more bits. The switch indicator bit value instructs the TRP 352 to perform the switch.

As one example, the TRP 352 performs wireless communication (e.g. sending and/or receiving wireless signals) using the first set of RF components 402 by default. When the TRP 352 is to instead perform wireless communication using the second set of RF components 404, the apparatus sends a message to the TRP 352 with a switch indicator bit set to “true” (e.g. bit value of ‘1’). In response to receiving the message, the TRP 352 instead performs wireless communication using the second set of RF components 404. In some cases, the Boolean value of “false” (e.g. bit value of ‘o’) may be reserved and/or have another use.

In another example, the TRP 352 does not necessarily have a default mode of using the first set of RF components 402 or the second set of RF components 404. Instead, when the message having the switch indicator bit value is received from the apparatus, the TRP 352 switches the set of RF components being used. For example, if the TRP 352 is performing wireless communication using the first set of RF components 402 and the message having the switch indicator bit value is received, then the TRP 352 instead switches and performs wireless communication using the second set of RF components 404. If the TRP 352 is performing wireless communication using the second set of RF components 404 and the message having the switch indicator bit value is received, then the TRP 352 instead switches and performs wireless communication using the first set of RF components 402. In one embodiment, the switch indicator having a value of “true” (e.g. bit value of ‘1’) may trigger the switch to occur, whereas if the switch indicator has the value “false” (e.g. bit value of ‘o’) then the switch is not triggered to occur.

In another example, the switch indicator bit value in the message from the apparatus may identify the set of RF components to be used by the TRP 352. For example, a bit value of ‘1’ may indicate “communicate using RFU 1” and a bit value of ‘o’ may indicate “communicate using RFU 2”. The TRP 352 then switches RFU, if/as needed, to follow the indication in the switch indicator.

A message with a switch indicator value triggering a switch may be sent by the apparatus to the TRP 352 for multiple reasons, e.g. the apparatus is aware of: a need for better RF performance, and/or a poor channel condition for one or more UEs communicating with the TRP 352, and/or a time of day or other condition where high or low traffic load is expected, etc.

In other embodiments, a message from an apparatus indicates a switching condition. The TRP 352 evaluates the condition, e.g. in the processor 360 of the TRP 352. If/when the condition is met, the switching is triggered. For example, the message may instruct the TRP 352 that wireless communication should be performed using the second set of RF components 404 when the potential or predicted or expected or actual traffic load of the TRP 352 is within a range that exceeds a particular threshold. The value of the particular threshold may be present in the message from the apparatus. Then, when the potential or predicted or expected or actual traffic load of the TRP 352 exceeds the particular threshold, the TRP 352 performs wireless communication using the second set of RF components 404. The TRP 352 may then switch back to performing wireless communication using the first set of RF components 402 in response to any one or some of the following conditions: (1) the potential or predicted or expected or actual traffic load of the TRP 352 no longer exceeds the particular threshold; and/or (2) the potential or predicted or expected or actual traffic load of the TRP 352 drops below a second threshold lower than the particular threshold (to prevent too much switching back and forth if the traffic load remains close to the particular threshold); and/or (3) upon expiry of a timer, e.g. a timer may be started upon switching from the first set of RF components 402 to the second set of RF components 404, and upon expiry of the timer the TRP 352 switches back to the first set of RF components 402. The timer may help reduce the amount of time spent using the second set of RF components 404, which may thereby help in power savings. In one example, when the TRP 352 switches from the first set of RF components 402 to the second set of RF components 404, a timer is started, and upon expiry of the timer the TRP 352 switches back to the first set of RF components 402 if, upon expiry of the timer, the potential or predicted or expected or actual traffic load of the TRP 352 no longer exceeds the particular threshold or is below a second threshold lower than the particular threshold.

In another example, the message may instruct the TRP 352 that wireless communication should be performed using the second set of RF components 404 when the potential or predicted or expected or actual physical resource block (PRB) usage ratio of the TRP 352 is within a range that exceeds a particular threshold. The value of the particular threshold may be present in the message from the apparatus. In one example, the value of the particular threshold may be PRB usage ratio of 10%. Then, when the potential or predicted or expected or actual PRB usage ratio of the TRP 352 exceeds the particular threshold, the TRP 352 performs wireless communication using the second set of RF components 404. The TRP 352 may then switch back to performing wireless communication using the first set of RF components 402 in response to any one or some of the following conditions: (1) the potential or predicted or expected or actual PRB usage ratio of the TRP 352 no longer exceeds the particular threshold; and/or (2) the potential or predicted or expected or actual PRB usage ratio of the TRP 352 drops below a second threshold lower than the particular threshold (to prevent too much switching back and forth if the PRB usage ratio remains close to the particular threshold); and/or (3) upon expiry of a timer, e.g. a timer may be started upon switching from the first set of RF components 402 to the second set of RF components 404, and upon expiry of the timer the TRP 352 switches back to the first set of RF components 402. The timer may help reduce the amount of time spent using the second set of RF components 404, which may thereby help in power savings. In one example, when the TRP 352 switches from the first set of RF components 402 to the second set of RF components 404, a timer is started, and upon expiry of the timer the TRP 352 switches back to the first set of RF components 402 if, upon expiry of the timer, the potential or predicted or expected or actual PRB usage ratio of the TRP 352 no longer exceeds the particular threshold or is below a second threshold lower than the particular threshold.

In any of the examples above discussing traffic load or PRB usage ratio, the value at which the timer expires (i.e. the timer length) and/or the value of the second threshold may also be in the message from the apparatus. Also, the value of the second threshold does not necessarily have to be lower than the particular threshold, e.g. it may be equal to or higher than the particular threshold, which would result in switching back to the first set of RF components 402 more often. Moreover, the values possibly needed to be known by the TRP 352 (e.g. the particular threshold value and/or the second threshold value and/or the timer expiry value) do not all need to necessarily come from a message from the apparatus. Instead, one, some, or all of the values may be predefined (e.g. in a standard), and/or specified as an input parameter to the TRP 352 (e.g. indicated as one of several potential values), and/or specified by the wireless network operator.

In another example, the switching condition in the message from the apparatus is in the form of a specified time window, e.g. time of day. For example, the message indicates to the TRP 352 that the first set of RF components 402 is to be used between 12 am-6 am, in which case the TRP 352 uses the first set of RF components 402 between 12 am-6 am, and switches to the second set of RF components 404 between 6:01 am-11:59 pm. In another example, the message indicates to the TRP 352 that the second set of RF components 404 is to be used between 7 am-9 am and between 6 pm-8 pm, in which case the TRP 352 performs wireless communication using the second set of RF components 404 during those time windows and otherwise performs wireless communication using the first set of RF components 402. In some embodiments, the message from the apparatus implicitly indicates when to switch to a particular set of RF components. For example, if the message explicitly indicates to switch to the first set of RF components 402 between 12 am-6 am, then the message implicitly indicates to switch to the second set of RF components 404 between 6:01 am-11:59 pm.

In some embodiments, the TRP 352 may be triggered to switch from one set of RF components to the other set of RF components by way of any combination of the example triggers above. For example, the message from the apparatus may indicate that by default the first set of RF components 402 is to be used all the time except between 7 am-9 am and 6 pm-8 pm. However, if it is outside those time windows, the second set of RF components 404 may be temporarily used in response to PRB usage ratio or traffic load exceeding a particular threshold and/or in response to a message from the apparatus providing a switch indicator triggering the switch.

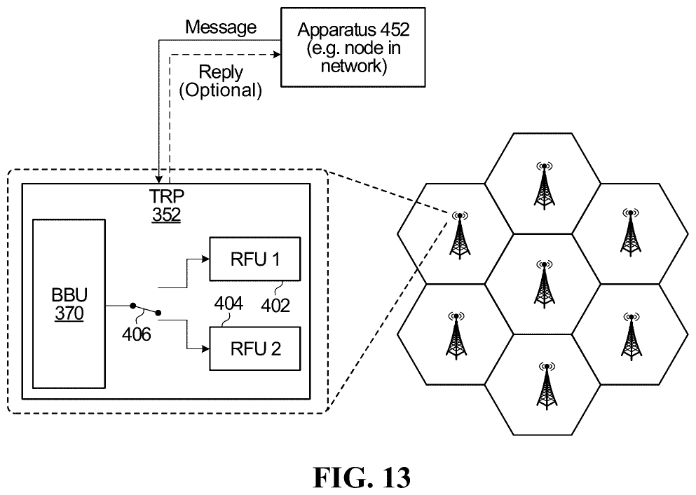

FIG. 13 illustrates an example of an apparatus 452, according to one embodiment. The apparatus 452 is separate from the TRP 352 and transmits, to the TRP 352, the message described above. For example, the message may carry the switch indicator triggering the switch, and/or the message may carry the switching condition described above. In some embodiments, the TRP 352 may optionally transmit a reply to the apparatus 452, e.g. a reply confirming that the message was received and/or a reply indicating that a switch between the first set of RF components 402 and the second set of RF components 404 occurred and/or a reply that explicitly or implicitly indicates which set of RF components is now being used by the TRP 352 to perform wireless communication.

In some embodiments, the apparatus 452 is a node in the wireless network. In one example, the node is another TRP, e.g., a neighbor TRP in the same wireless network. In another example, the node is a “super TRP”. A super TRP is a TRP that has a coverage area typically encompassing the coverage areas (or parts of coverage areas) of multiple TRPs. In another example, the node is a server in the wireless network, such as a wireless network management system controlled by the wireless operator.

The node may be able to control (e.g. send the message to) multiple TRPs, not just TRP 352. Several TRPs may each implement the first and second set of RF components, and the node may be able to trigger a particular TRP and/or multiple TRPs to use a particular set of RF components to control trade-off or balance between the whole wireless network power savings and wireless network performance. As one example, the node may be a super TRP or wireless management system that may: (1) send a message to indicate that a first TRP is to use the first set of RF components 402; (2) send a message to indicate that a second TRP is to use the second set of RF components 404; and (3) instruct the first TRP to inform a UE served by the first TRP to handover to the second TRP. The UE is handed over from the first TRP to the second TRP. The second TRP is already using the second set of RF components 404, so having another UE also communicate with the second TRP is better (from an overall power savings perspective) than switching the first TRP from the first set of RF components 402 to the second set of RF components 404 to meet the performance requirements of that UE. A balance is thereby provided: power savings is achieved by the first TRP using the first set of RF components 402, and one or more UEs may instead communicate with a second TRP to allow target performance requirements to be met.

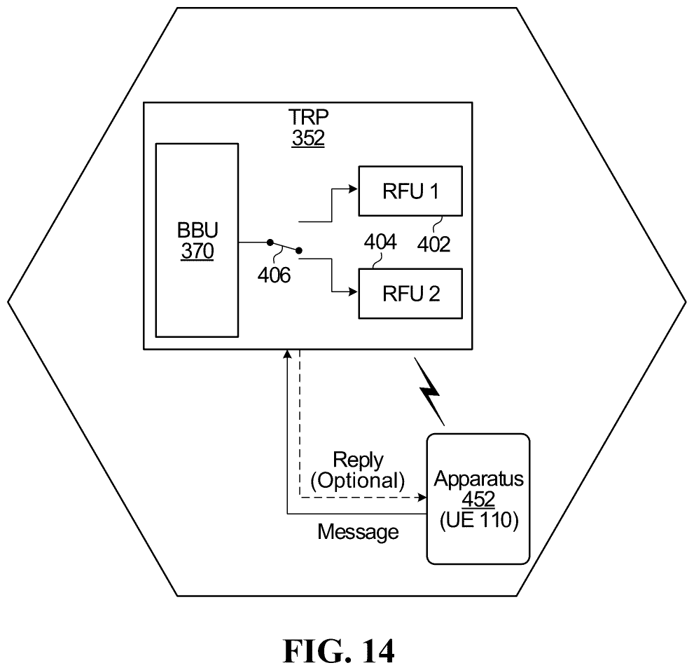

FIG. 14 illustrates an example in which apparatus 452 is a UE, illustrated as UE 110. The UE 110 is wirelessly communicating with the TRP 352, e.g. the UE 110 is being served by the TRP 352. The TRP 352 is wirelessly communicating with the UE 110 using the first set of RF components 402. It is determined by the UE 110 and/or by the TRP 352 that the UE 110 is experiencing a poor channel condition (e.g. by way of measuring a parameter of the channel) and/or that the UE 110 is experiencing poor user-perceived throughput. In response, the UE 110 transmits the message to the TRP 352 with a switch indicator triggering the TRP 352 to instead perform wireless communication using the second set of RF component 404. The second set of RF components 404 consumes more power, but may help overcome the poor channel condition and/or increase user-perceived throughput, e.g. through the use of additional RF chains. In some embodiments, the TRP 352 may optionally transmit a reply to the UE 110, e.g. a reply confirming that the message was received and/or a reply indicating that a switch to the second set of RF components 404 occurred and/or a reply that explicitly or implicitly indicates which set of RF components is now being used by the TRP 352 to perform wireless communication.

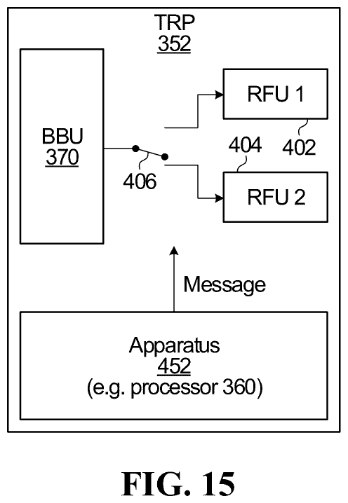

FIG. 15 illustrates an example in which the apparatus 452 is instead part of the TRP 352 itself. For example, the processor 360 in the TRP 352 may implement the apparatus 452. The processor 360 may issue a message with a switch indicator value triggering a switch and/or directly control the switch itself (e.g. the message may be a control signal that controls switch 406). The message may be generated in response to a particular triggering condition being met, examples of which are described earlier, e.g.: a need for better RF performance, and/or a poor channel condition for one or more UEs communicating with the TRP 352, and/or a particular time of day, and/or a potential or predicted or expected or actual traffic load of the TRP 352 falling within a particular range (e.g. exceeding a threshold), and/or a potential or predicted or expected or actual PRB usage ratio of the TRP 352 falling within a given range (e.g. exceeding a threshold), and/or expiry of a timer, etc. In one example, similar to that explained earlier, the TRP 352 determines that wireless communication should be performed using the second set of RF components 404 when the potential or predicted or expected or actual traffic load and/or PRB usage ratio of the TRP 352 falls within a range that exceeds a particular threshold. The TRP 352 may then switch back to performing wireless communication using the first set of RF components 402 in response to any one or some of the following conditions: (1) the potential or predicted or expected or actual traffic load and/or PRB usage ratio of the TRP 352 no longer exceeds the particular threshold; and/or (2) the potential or predicted or expected or actual traffic load and/or PRB usage ratio of the TRP 352 drops below a second threshold lower than the particular threshold; and/or (3) upon expiry of a timer, e.g. a timer may be started upon switching from the first set of RF components 402 to the second set of RF components 404, and upon expiry of the timer the TRP 352 switches back to the first set of RF components 402. In one example, when the TRP 352 switches from the first set of RF components 402 to the second set of RF components 404, a timer is started, and upon expiry of the timer the TRP 352 switches back to the first set of RF components 402 if, upon expiry of the timer, the potential or predicted or expected or actual traffic load and/or PRB usage ratio of the TRP 352 no longer exceeds the particular threshold or is below a second threshold lower than the particular threshold. The value at which the timer expires and/or the value of the particular threshold and/or the value of the second threshold may be received from another device on the network, and/or it may be predefined (e.g. in a standard), and/or it may be specified as an input parameter to the TRP 352 (e.g. indicated as one of several potential values), and/or it may be specified by the wireless network operator, and/or it may be determined by the TRP 352. Also, the value of the second threshold does not necessarily have to be lower than the particular threshold, e.g. it may be equal to or higher than the particular threshold.

In the examples illustrated in FIGS. 13 to 15, the first set of RF components 402 is illustrated as a first RFU (“RFU 1”), and the second set of RF components 404 is illustrated as a second RFU (“RFU 2”). This is only an example, and is based on the embodiment shown in FIG. 8. Instead, as another example, the first set of RF components 402 and second set of RF components 404 may be that shown in any of the examples illustrated in relation to FIGS. 10 to 12.

In all of the examples explained herein, e.g. in relation to FIGS. 7 to 15, it may be the case that both the first set of RF components 402 and the second set of RF components 404 remain powered on in a “ready to communicate” (e.g. “waiting”) state, when not being used to perform wireless communication. Power is consumed when in the “ready to communicate” state. The power consumed is referred to as the static power consumption. The static power consumption of the first set of RF components 402 may be less than the static power consumption of the second set of RF components 404. By remaining in the “ready to communicate” state, there may be little or no service interruption when the switch 406 switches from one set of RF components to the other set of RF components. Each set of RF components is ready to immediately perform wireless communication whenever the switch 406 switches to use that set of RF components. The wireless network always remains online to service UEs. In an alternative embodiment, if the switch 406 is set to use one set of the RF components, then the other unused set of RF components is powered off or enters into a lower-power sleep state. This may result in lower power consumption. Before the switch 406 switches to that unused set of RF components, the unused set of RF components is returned to a state of “ready to communicate”.

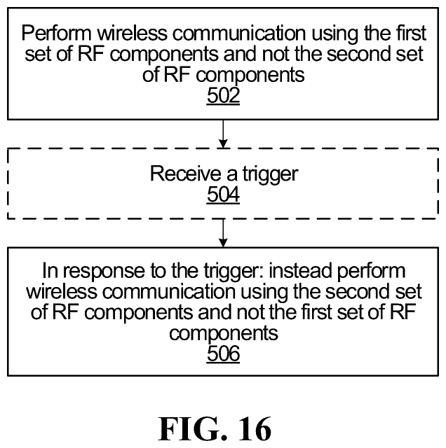

FIG. 16 illustrates a method performed by TRP 352 in a wireless network, according to one embodiment. The TRP 352 includes a first set of RF components 402 and a second set of RF components 404. The first set of RF components 402 consumes less power than the second set of RF components 404. The TRP 352 may be the TRP 352 illustrated in any one of the embodiments described above in relation to FIGS. 7 to 15.

At step 502, the TRP 352 performs wireless communication using the first set of RF components 402 and not the second set of RF components 404. A wireless communication may comprise transmitting (e.g. sending a wireless signal to one or more UEs) and/or receiving (e.g. receiving a wireless signal from one or more UEs).

Optionally, at step 504, the TRP 352 receives a trigger, e.g. in a message from an apparatus.

At step 506, in response to a trigger, the TRP 352 instead performs wireless

communication using the second set of RF components 404 and not the first set of RF components 402. The trigger may be any one of the triggers described earlier.

In some embodiments in the method of FIG. 16, the first set of RF components 402 comprises a first RFU and the second set of RF components 404 comprises a different second RFU. Although not necessary, in some embodiments the first RFU and the second RFU may communicate with a same BBU in the TRP 352, as is the case in the example described in relation to FIG. 8. In other embodiments, there may be two separate BBUs, one corresponding to each set of RF components. In some embodiments, the first RFU may have fewer power amplifiers than the second RFU, as is the case in the example described in relation to FIG. 9.

In some embodiments in the method of FIG. 16, the first set of RF components 402 has at least one of: a reduced circuit chip area compared to the circuit chip area of the second set of RF components 404; a reduced RF component size compared to the RF component size of the second set of RF components 404; a fewer number of RF components compared to the number of RF components in the second set of RF components 404; a fewer number of crystal oscillators compared to the number of crystal oscillators in the second set of RF components 404; a fewer number of filters compared to the number of filters in the second set of RF components 404; or a fewer number of power amplifiers compared to the number of power amplifiers in the second set of RF components 404.

In some embodiments in the method of FIG. 16, a static power consumption of the first set of RF components 402 is less than the static power consumption of the second set of RF components 404. The static power consumption of the first set of RF components 402 may be defined as the power consumption of the first set of RF components 402 when the first set of RF components 402 are powered and ready for wireless communication but are not performing wireless communication. The static power consumption of the second set of RF components 404 may be defined as the power consumption of the second set of RF components 404 when the second set of RF components 404 are powered and ready for wireless communication but are not performing wireless communication.

In some embodiments in the method of FIG. 16, during the performing wireless communication using the first set of RF components 402, the second set of RF components 404 remains powered and ready for wireless communication but is not being used to perform wireless communication. In some embodiments in the method of FIG. 16, during the performing wireless communication using the second set of RF components 404, the first set of RF components 402 remains powered and ready for wireless communication but is not being used to perform wireless communication.

In some embodiments in the method of FIG. 16, the trigger comprises at least one of: a message from an apparatus triggering a switch from the first set of RF components to the second set of RF components; a predicted or expected or actual traffic load of the TRP being within a particular range; a predicted or expected or actual PRB usage ratio of the TRP being within a given range; a wireless channel condition between the TRP and a UE being at or below a particular value; a throughput for the UE being at or below a particular throughput value; expiry of a timer; or a time being within a particular time range/window. The apparatus may be a node in a wireless network (like in the example in FIG. 13) or a UE communicating with the TRP 352 (like in the example in FIG. 14). In some embodiments, the apparatus is the node in the wireless network (like in the example in FIG. 13), and the node is in communication with multiple TRPs and instructs, for each of one or more of the multiple TRPs, which set of RF components is to be used for wireless communication by that TRP.

Any of the examples described earlier, e.g. in relation to FIGS. 7-15, may be incorporated into the method of FIG. 16.

Benefits of some embodiments above include the flexibility to control and switch between a lower-power set of RF components 402 and a higher-power higher-performance set of RF components 404. This may allow for trade-off and/or balance between the power consumption of the TRP 352 and performance of wireless network provided by the TRP 352. In some implementations, the power consumption of TRP 352 may potentially be reduced by around 20% without scarifying wireless network performance and user-perceived throughput.

Although the method of FIG. 16 is described as being performed by TRP 352, more generally the method may be performed by a device. The device may be a network device, such as a TRP. In some embodiments, the device may be located within a TRP or other network component, e.g. the device may comprise one or more circuit chips. The device may possibly include the first set of RF components 402 and/or the second set of RF components 404. The device may instead or further include at least one processor, and a memory storing processor-executable instructions. The processor-executable instruction, when executed by the at least one processor, may cause the at least one processor to perform any of the methods of the TRP 352 described herein, e.g. the method described in relation to FIG. 16. For example, the device may be controlled to directly perform or cause one or more other components or systems to: (1) perform wireless communication using the first set of RF components and not the second set of RF components; (2) in response to a trigger: instead perform wireless communication using the second set of RF components and not the first set of RF components. In some embodiments, the processor may cause the device to perform the wireless communication by preparing bits for transmission (e.g. encoding the bits), and instructing the selected RF components to transmit the bits, as well as instructing the selected RF components to receive wireless signals, and processing (e.g. decoding) the wireless signals.

### UE-Side Embodiments

The embodiments above focus on the operations of the TRP 352. However, the operation of the UE 110, and/or the communication between the UE 110 and TRP 352, may change having regard to whether the TRP 352 is performing wireless communication using the first set of RF components 402 or the second set of RF components 404.

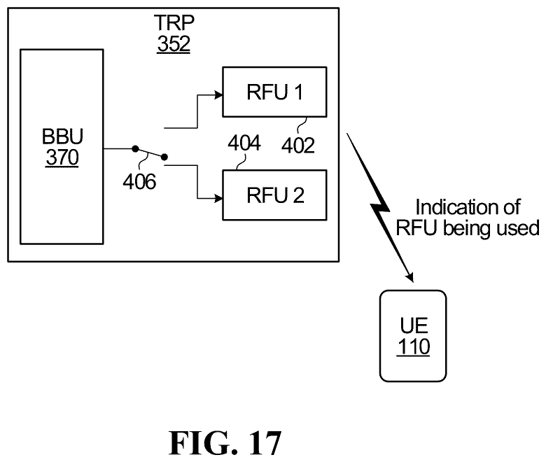

FIG. 17 illustrates TRP 352 communicating with UE 110, according to one embodiment. The TRP 352 may be the TRP 352 of any of the examples described earlier in relation to FIGS. 7 to 15. As one example, although FIG. 17 illustrates the first set of RF components 402 as a first RFU (“RFU 1”) and the second set of RF components 404 as a second RFU (“RFU 2”), this is only an example. The first set of RF components 402 and second set of RF components 404 may instead be that shown in any of the examples illustrated in relation to FIGS. 10 to 12.

In some embodiments, the TRP 352 operates in two different modes of operation: a first mode of operation when the first set of RF components 402 is being used, and a second mode of operation when the second set of RF components 404 is being used. The mode of operation may impact the measurements performed by the TRP 352, and/or may impact the number of bits transmitted and/or received by the TRP 352, examples of which are explained later. The TRP 352 transmits, to the UE 110, an indication of which set of RF components is being used by the TRP 352 to perform wireless communication with the UE 110. The indication may be explicit, e.g. the indication may identify the set of RF components being used. Alternatively, the indication may be implicit, e.g. the indication may indicate a particular mode of operation or indicate a particular DCI format or allocate a particular resource, which the UE 110 associates with a particular set of RF components.

The UE 110 may also operate in two different modes of operation: a first mode of operation when the first set of RF components 402 are being used by the TRP 352, and a second mode of operation when the second set of RF components 404 are being used by the TRP 352. The indication from the TRP 352 informs the UE 110 of which set of RF components is being used by the TRP 352, and in response the UE 110 operates in the corresponding mode of operation. The mode of operation may impact the measurements performed by the UE 110, and/or may impact the number of bits transmitted and/or received by the UE 110.

In some embodiments, when the TRP 352 is wirelessly communicating using the first set of RF components 402, the TRP 352 does not schedule a higher modulation order (e.g. 256 QAM or 64 QAM) for a wireless communication because the first set of RF components 402 has lower performance. As a result, the field in the DCI indicating modulation-and-coding scheme (MCS) may have a reduced number of bits, e.g. 3 bits instead of 4 bits. Transmission overhead is thereby saved. The UE 110 knows, based on the indication, that the TRP 352 is using the first set of RF components 402, and as a result the UE 110 operates in a mode of operation in which the UE 110 receives and decodes a DCI format in which 3 bits are used to specify MCS instead of 4 bits.

In another example, when the TRP 352 is wirelessly communicating using the first set of RF components 402, the UE 110 operates in a mode in which the UE 110 exerts less effort/less complexity in measuring certain parameters. For example, the UE 110 may exert less effort/less complexity in measuring a wireless channel parameter, such as a parameter related to channel condition, e.g. channel quality indicator (CQI). This may result in power savings for the UE 110. In some embodiments, the measured parameter (e.g. CQI) may be indicated by the UE 110 using fewer bits than if the TRP 352 was wirelessly communicating using the second set of RF components 404. For example, 3 bits may be used to transmit the CQI value instead of 4 bits. Transmission overhead may therefore be reduced.

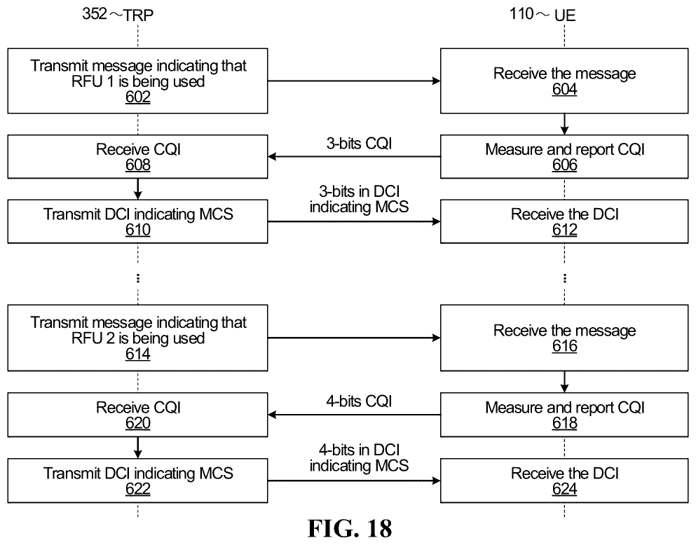

FIG. 18 illustrates a method performed by TRP 352 and UE 110, according to one embodiment. In the method of FIG. 18, the first set of RF components 402 is a first RFU (“RFU 1”), and the second set of RF components 404 is a different second RFU (“RFU 2”).

At step 602, the TRP 352 transmits, to UE 110, a message indicating that RFU 1 is being used by the TRP 352 for wireless communication with the UE 110. At step 604, the UE 110 receives the message. In response, the UE 110 operates in a first mode of operation. In that first mode of operation, at step 606, the UE 110 measures a wireless channel parameter to obtain a CQI value. The UE 110 may perform the measurement with less effort/less complexity, as explained above. The CQI value is transmitted to the TRP 352, e.g. in an uplink transmission. The CQI value is represented using 3 bits. At step 608, the TRP 352 receives the CQI by receiving, using RFU 1, the wireless signal transmitted from UE 110 that carries the CQI. The TRP 352 decodes the CQI. The TRP 352 operates in a mode of operation in which the TRP 352 knows that the format of the CQI is only 3 bits because the TRP 352 is using RFU 1. The TRP 352 determines a MCS to indicate to the UE 110, e.g. possibly based on the CQI value received at step 608. At step 610, the TRP 352 transmits, to UE 110, a DCI. The DCI has a format in which 3 bits are used to represent the MCS value. At step 612, the UE 110 receives the DCI and decodes the DCI, including the MCS value. The UE 110 operates in a mode of operation in which the UE 110 knows that the format of the DCI includes an MCS value of 3 bits because the TRP 352 is using RFU 1.

At a different point in time, the TRP 352 switches and instead performs wireless communication using RFU 2. The switching may occur in response to a trigger, e.g. in response to any of the triggers described earlier. At step 614, the TRP 352 transmits, to UE 110, a message indicating that RFU 2 is being used by the TRP 352 for wireless communication with the UE 110. At step 616, the UE 110 receives the message. In response, the UE 110 operates in a second mode of operation. In that second mode of operation, at step 618, the UE 110 measures a wireless channel parameter to obtain a CQI value. The UE 110 may perform the measurement with more effort/more complexity compared to at step 606. The CQI value is transmitted to the TRP 352, e.g. in an uplink transmission. The CQI value is represented using 4 bits, instead of 3 bits. At step 620, the TRP 352 receives the CQI by receiving, using RFU 2, the wireless signal transmitted from UE 110 that carries the CQI. The TRP 352 decodes the CQI. The TRP 352 operates in a mode of operation in which the TRP 352 knows that the format of the CQI is 4 bits because the TRP 352 is using RFU 2. The TRP 352 determines a MCS to indicate to the UE 110, e.g. possibly based on the CQI value received at step 620. At step 622, the TRP 352 transmits, to UE 110, a DCI. The DCI has a format in which 4 bits are used to represent the MCS value. The additional bit (4 bits instead of 3 bits to represent MCS) allows for a higher-order modulation to be indicated in the DCI, e.g. 256-QAM. At step 624, the UE 110 receives the DCI and decodes the DCI, including the MCS value. The UE 110 operates in a mode of operation in which the UE 110 knows that the format of the DCI includes an MCS value of 4 bits because the TRP 352 is using RFU 2.

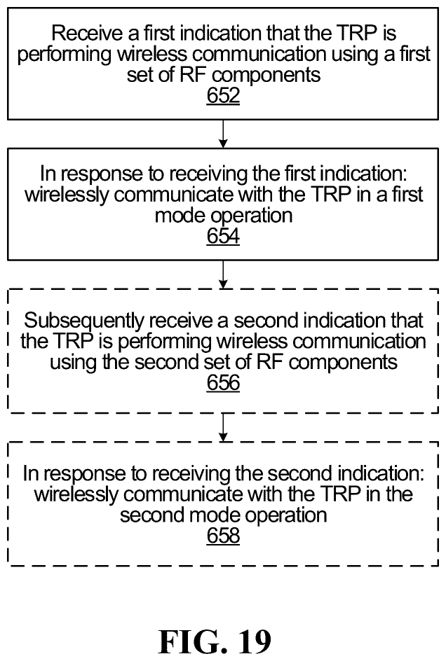

FIG. 19 illustrates a method performed by UE 110, according to one embodiment. At step 652, the UE 110 receives, from a TRP (e.g. TRP 352), a first indication that the TRP is performing wireless communication using a first set of RF components 402 different from a second set of RF components 404. At step 654, in response to receiving the first indication, the UE 110 wirelessly communicates with the TRP in a first mode operation different from a second mode of operation.

Optionally, at step 656, the method may further include subsequently receiving, from the TRP, a second indication that the TRP is performing wireless communication using the second set of RF components. Optionally, at step 658, in response to receiving the second indication, the UE 110 wirelessly communicates with the TRP in the second mode operation.

In some embodiments of the method of FIG. 19, fewer bits may be wirelessly communicated in order to indicate a particular value when operating in the first mode of operation compared to when operating in the second mode of operation. For example, in the first mode of operation fewer bits may be used by the UE 110 to report a channel measurement (e.g. CQI) compared to in the second mode of operation. An example is in FIG. 18 in which CQI is reported using fewer bits (3 bits) in the mode of operation corresponding to the first set of RF components 402, and CQI is reported using more bits (4 bits) in the mode of operation corresponding to the second set of RF components 404. As another example, in the first mode of operation fewer bits may be used in DCI to indicate MCS compared to in the second mode of operation. An example is in FIG. 18 in which MCS is indicated in DCI using fewer bits (3 bits) in the mode of operation corresponding to the first set of RF components 402, and MCS is indicated in DCI using more bits (4 bits) in the mode of operation corresponding to the second set of RF components 404.

Any of the examples explained earlier, e.g. in relation to FIGS. 7 to 18, may be incorporated into the method of FIG. 19. For example, in some embodiments, the method of FIG. 19 may further include the UE 110 transmitting a message to the TRP, the message requesting that the TRP use the second set of RF components 404 for the wireless communication instead of the first set of RF components 402. This is the case in the example in FIG. 14 in which the UE 110 sends the switch indicator message to the TRP 352 to trigger a switch, e.g. because of a poor wireless channel condition and/or poor user-perceived throughput for the UE 110. For example, the message may be transmitted in response to a wireless channel condition between the TRP 352 and the UE 110 being at or below a particular value.

In some embodiments of the method of FIG. 19, when the first set of RF components 402 is being used for wireless communication, the second set of RF components 404 is not being used for wireless communication. In some embodiments of the method of FIG. 19, when the second set of RF components 404 is being used for wireless communication, the first set of RF components 402 is not being used for wireless communication.

In some embodiments of the method of FIG. 19, the second set of RF components 404 results in better performance than the first set of RF components 402. In some embodiments of the method of FIG. 19, the second set of RF components 404 consumes more power than the first set of RF components 402.

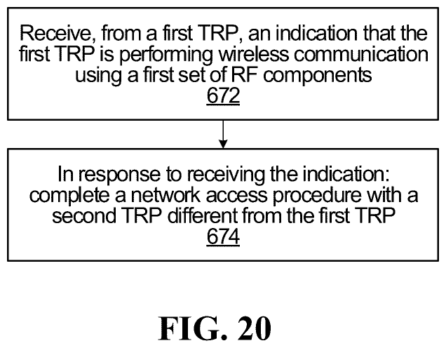

FIG. 20 illustrates a method performed by UE 110, according to another embodiment. At step 672, the UE 110 receives, from a first TRP, an indication that the first TRP is performing wireless communication using a first set of RF components 402. In response to receiving the indication, at step 674, the UE 110 completes a network access procedure with a second TRP different from the first TRP.

The method of FIG. 20 may be applicable when the UE 110 is trying to access a wireless network (e.g. upon power-up) and has the possibility to perform or complete an initial network access procedure with several TRP candidates. When the UE 110 receives an indication that a first TRP is using the first set of RF components 402 (step 672), the UE 110 may be triggered to preferably avoid connecting to the network using that TRP, if possible, because that TRP will not support as high performance. In response, the UE 110 may select another candidate TRP (the second TRP).

The initial access procedure performed by the UE 110 is implementation specific, but may include operations relating to synchronization, decoding and reading the system information, generating a random access request for transmission, etc. For example, in one implementation: the UE 110 searches for one or more synchronization signals, e.g. a primary synchronization signal (PSS) and a secondary synchronization signal (SSS); the UE 110 decodes a physical broadcast channel (PBCH) to read a master information block (MIB) in order to obtain necessary system information; information in system information blocks (SIBs) are also read; and the UE 110 performs a random access procedure. The random access procedure is sometimes referred to as a random access channel (RACH) procedure and may include: transmission of a preamble (RACH preamble) (“msg1”) by UE 110; receipt of a random access response (RAR) (“msg2”) from a TRP; transmission of information, such as a RRC connection request (“msg3”) by UE 110; and a response to msg3 (“msg4”), e.g. connection confirmation information, from a TRP.

In some embodiments, the method of FIG. 20 may further include receiving, from the second TRP, an indication that the second TRP is performing wireless communication using a second set of RF components 404. The switching to the second TRP to perform or complete the network access procedure may be performed by the UE 110 in response to also receiving the indication that the second TRP is performing wireless communication using the second set of RF components 404.

In some embodiments of the method of FIG. 20, the second set of RF components 404 results in better performance than the first set of RF components 402. In some embodiments of the method of FIG. 20, the second set of RF components 404 consumes more power than the first set of RF components 402.

Any of the examples explained earlier, e.g. in relation to FIGS. 7 to 19, may be incorporated into the method of FIG. 20.

Although the method of FIGS. 19 and 20 are described as being performed by UE 110, more generally the method may be performed by an apparatus. The apparatus may be a UE or some other electronic device. In some embodiments, the apparatus may be located within a UE, e.g. the apparatus may comprise one or more circuit chips. The apparatus may include at least one processor, and a memory storing processor-executable instructions. The processor-executable instruction, when executed by the at least one processor, may cause the at least one processor to perform any of the methods of the UE 110 described herein, e.g. the methods described in relation to FIG. 19 and/or 20. For example, the processor may: (1) receive a first indication that a TRP is performing wireless communication using a first set of RF components different from a second set of RF components; and (2) in response to receiving the first indication: cause the apparatus to wirelessly communicate with the TRP in a first mode operation different from a second mode of operation. The processor may cause the apparatus to perform the wireless communication by preparing bits for transmission (e.g. encoding the bits), and instructing the transmitter to transmit the bits, as well as instructing the receiver to receive wireless signals, and processing (e.g. decoding) the wireless signals.

Finally, although all of the embodiments described herein (e.g. in relation to FIGS. 7 to 20) are often in the context of the wireless communication being a transmission by a TRP, the embodiments may equally apply to reception. For example, the first set of RF components 402 (lower power) and the second set of RF components 404 (higher power) may be RF components used or also or instead for receiving wireless signals from UEs. The second set of RF components 404 target higher performance, e.g. successful reception/decoding by the TRP 352 in the presence of poor channel conditions and/or interference.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by a user equipment (UE), the method comprising:
receiving, from a transmit-and-receive point (TRP), a first indication that the TRP is performing wireless communication using a first set of radio frequency (RF) components different from a second set of RF components; and
in response to receiving the first indication: wirelessly communicating with the TRP in a first mode of operation different from a second mode of operation.

2. The method of claim 1, wherein fewer bits are wirelessly communicated in order to indicate a particular value when operating in the first mode of operation than when operating in the second mode of operation.

3. The method of claim 1, further comprising:
subsequent to the wirelessly communicating with the TRP in the first mode of operation, receiving, from the TRP, a second indication that the TRP is performing the wireless communication using the second set of RF components; and
in response to receiving the second indication: wirelessly communicating with the TRP in the second mode of operation.

4. The method of claim 1, wherein fewer bits are used by the UE to report a channel measurement when operating in the first mode of operation than when operating in the second mode of operation.

5. The method of claim 1, wherein fewer bits are used in downlink control information (DCI) to indicate a modulation-and-coding scheme (MCS) when operating in the first mode of operation than when operating in the second mode of operation.

6. The method of claim 1, further comprising:
transmitting a message to the TRP, the message requesting that the TRP use the second set of RF components for the wireless communication instead of the first set of RF components.

7. The method of claim 6, wherein the message is transmitted in response to a wireless channel condition between the TRP and the UE being at or below a particular value.

8. The method of claim 1, wherein, when the first set of RF components is being used for the wireless communication the second set of RF components is not being used for the wireless communication, and wherein, when the second set of RF components is being used for the wireless communication, the first set of RF components is not being used for the wireless communication.

9. The method of claim 1, wherein the second set of RF components results in better performance than the first set of RF components.

10. The method of claim 1, wherein the second set of RF components consumes more power than the first set of RF components.

11. A device comprising:
a first set of radio frequency (RF) components;
a second set of RF components different from the first set of RF components;
at least one processor; and
a memory storing processor-executable instructions that, when executed by the at least one processor, cause the device to:
perform wireless communication using the first set of RF components and not the second set of RF components; and
in response to a trigger: perform the wireless communication using the second set of RF components and not the first set of RF components,
wherein the first set of RF components consumes less power than the second set of RF components.

12. The device of claim 11, wherein the first set of RF components comprises a first RF unit (RFU), and the second set of RF components comprises a different second RFU.

13. The device of claim 12, wherein the device further includes a baseband unit (BBU), and wherein the first RFU and the second RFU communicate with the BBU.

14. The device of claim 12, wherein the first RFU has fewer power amplifiers than the second RFU.

15. The device of claim 11, wherein the first set of RF components has at least one of: a reduced circuit chip area than a circuit chip area of the second set of RF components; a reduced RF component size than an RF component size of the second set of RF components; a fewer number of RF components than a number of RF components in the second set of RF components; a fewer number of crystal oscillators than a number of crystal oscillators in the second set of RF components; a fewer number of filters than a number of filters in the second set of RF components; or a fewer number of power amplifiers than a number of power amplifiers in the second set of RF components.

16. The device of claim 11, wherein a first static power consumption of the first set of RF components is less than a second static power consumption of the second set of RF components, wherein the first static power consumption of the first set of RF components is a first power consumption of the first set of RF components when the first set of RF components are powered and ready for the wireless communication but are not performing the wireless communication, and wherein the second static power consumption of the second set of RF components is a second power consumption of the second set of RF components when the second set of RF components are powered and ready for the wireless communication but are not performing the wireless communication.

17. The device of claim 11, wherein, during the performing the wireless communication using the first set of RF components, the second set of RF components remains powered and ready for the wireless communication but is not being used to perform wireless the communication, and wherein, during the performing the wireless communication using the second set of RF components, the first set of RF components remains powered and ready for the wireless communication but is not being used to perform the wireless communication.

18. The device of claim 11, wherein the device comprises a transmit-and-receive point (TRP), and wherein the trigger comprises at least one of: a message from an apparatus triggering a switch from the first set of RF components to the second set of RF components; a predicted or expected or actual traffic load of the TRP being within a particular range; a predicted or expected or actual physical resource block (PRB) usage ratio of the TRP being within a given range; a wireless channel condition between the TRP and a user equipment (UE) being at or below a particular value; a throughput for the UE being at or below a particular throughput value; expiry of a timer; or a time being within a particular time range.

19. An apparatus comprising:
at least one processor; and
a memory storing processor-executable instructions that, when executed by the at least one processor, cause the apparatus to perform operations comprising:
receiving a first indication that a transmit-and-receive point (TRP) is performing wireless communication using a first set of radio frequency (RF) components different from a second set of RF components; and
in response to receiving the first indication: wirelessly communicating with the TRP in a first mode of operation different from a second mode of operation.

20. The apparatus of claim 19, the operations further comprising:
subsequent to the wirelessly communicating with the TRP in the first mode of operation, receiving a second indication that the TRP is performing the wireless communication using the second set of RF components; and
in response to receiving the second indication: wirelessly communicating with the TRP in the second mode of operation.
